(19) United States
(12) Patent Application Publication
(10) Pub. No.: US 2017/0244959 A1
(43) Pub. Date: Aug. 24, 2017

(54) Selecting a View of a Multi-View Video

(71) Applicant: Adobe Systems Incorporated, San Jose, CA (US)

(72) Inventors: Angela Ranjeet, Bangalore (IN); Pavan Kumar, Bangalore (IN); Kiran Chandra Zagabattuni, Bangalore (IN); Dwight O. Rodgers, Mountain View, CA (US)

(21) Appl. No.: 15/048,874

(22) Filed: Feb. 19, 2016

(51) Int. Cl. H04N 13/04; G06F 3/0484; G06T 7/20; H04N 5/232; G11B 27/34

(52) U.S. Cl. CPC H04N 13/0445; H04N 5/23238; G11B 27/34; G06T 7/2093; G06F 3/04847; G06T 2207/10016; G06T 2200/24

(57) ABSTRACT

Techniques for selecting a view of a video are described for videos having multiple views of a real-world scene that are captured simultaneously. When playback of a video is initiated, an object of interest is identified and tracked by automatically switching between multiple views of the video in order to maintain the object in view within a viewport as the object moves between the multiple views. A user input may be received at a scrub bar of the viewport, prompting generation of a thumbnail preview of the video based on a selected view of the video and a time of the video relating to the user input. The correction may be based on a view that is currently displayed in the viewport.

### BACKGROUND

As computing technology advances, the ability of users to create, share, and edit and view videos and other multi-media content has increased accordingly. Additionally, advances in digital cameras have made it easier for users to create multi-view videos that include images captured in two or more directions. One example of a multi-view video is a three-hundred-sixty degree (360°) video that captures images of a scene in multiple directions and stitches the images together to provide 360° viewing experience.

Unfortunately, techniques utilized by current content viewing applications have not adequately adapted to 360° and other multi-view content. For example, user interface tools and controls designed for traditional, single-view videos do not translate well to multi-view controls and may not support enhanced features enabled by the video formats. For instance, navigation controls for multi-view videos may lack indications that multi-views are available and may provide distorted representations of the multi-view videos. These problems may lead to a bad user experience with evolving video technology, and the content creator may lose viewers and revenue as a result.

Videos having multiple views may be captured by a single camera having a single, wide angle lens; a single camera having multiple lenses that overlap in capture and are “stitched” together to form a contiguous image; or multiple cameras with respective lenses that are stitched together to form a contiguous image.

One example of videos having multiple camera views captured simultaneously are 360° videos. As noted above, a 360° video is a video recording of a real world scene, where the view in multiple directions is recorded at the same time. As devices to capture 360° videos have become more accessible to users, so too has the amount of content available to viewers that was generated by these devices. Unfortunately, traditional video viewing applications have not adequately adapted to this new form of content. Users who wish to watch videos having multiple camera views are faced with cumbersome and unintuitive means for navigating these videos in both space and time.

Techniques are described herein for selecting a view of a video including multiple camera views of a scene captured simultaneously. In order to provide some context for implementations described herein, an example scenario is proposed. In this example scenario, a viewer may select a 360° video for viewing that shows a dog playing fetch with a person. The view presented to the viewer in the viewport may initially show the dog and the user before the user throws the ball. If the person in the video throws the ball over the camera capturing the 360° video, the camera captures the ball as it flies over the camera, the dog as it chases the ball next to the camera, and the user who remains stationary after throwing the ball, all simultaneously in the 360° video. One way to present this 360° video to the viewer in a video viewing environment is to display the video in a “fisheye” configuration that displays all of the captured camera angles simultaneously and stitched together such that there are no breaks or seams between the views captured by the camera. However, the fisheye configuration appears distorted when displayed on a two-dimensional screen, and can be disconcerting and difficult for users to view the 360° video in this manner.

Instead of displaying 360° videos in the fisheye configuration, many video viewing applications display 360° videos by selecting one of the multiple camera viewing angles that were captured, and displaying the area that was captured in that camera view similar to how a video captured with only one camera viewing angle is presented. Returning to the example above, the 360° video of the person throwing the ball for the dog may be displayed starting with the person with the ball and the dog all in the viewport of the 360° video. When the person throws the ball in the video, the view of the 360° video remains fixed on the person throwing the ball absent any input by the viewer. If the viewer wishes to track the ball or the dog as they move outside of the current viewing angle of the 360° video, the viewer must manually navigate to follow the ball or the dog and maintain these objects in the current field of view.

Additionally, in these current video viewing applications, little to no advancements have been made with respect to navigation along a timeline of the 360° video. Again returning to the above example, if the viewer wishes to skip ahead in the 360° video to the next time the person throws the ball, the user may hover an input over a scrub bar in the video viewing application. A scrub bar may be a visual representation of an amount of playback of the video, and may also be configured to receive various user inputs to navigate a timeline associated with the video. When the viewer hovers over the scrub bar, a thumbnail preview window may appear displaying content of the 360° video at the point in time which the user is hovering on the scrub bar. Current video viewing applications only display thumbnail previews of content of 360° videos in the fisheye configuration however. While a fisheye configuration is already distorted and disconcerting for viewers, these effects are compounded in the small-scale nature of the thumbnail preview, making the preview nearly incomprehensible. This makes it especially difficult for viewers to find a location on a video timeline based on a scene that they may be searching for. Relating back to the above example, the small thumbnail preview displayed as a fisheye configuration would make it very difficult for the viewer to locate the scene at the point in time that the person throws the ball next.

### SUMMARY

Techniques to select a view in a multi-view video are described. In one or more implementations, a video is accessed via a video viewing application in a digital media viewing environment. The video may include multiple views of a scene captured simultaneously by a camera system configured to capture images for the scene in multiple directions corresponding to the multiple views, such as a 360° video. Playback of the video is initiated in a viewport exposed by the viewing application. The viewport is designed to selectively switch between presentation of the multiple views of the video at different times. During playback of the video, a subject of interest is identified and tracked by automatically switching between the multiple views to maintain the at least one object in view within the viewport.

Additionally, a scrub bar of the viewport is provided to display a visual representation of a timeline of the video and the video's playback progress. The scrub bar provides controls to navigate to different points in the video. When user input is received at the scrub bar, a thumbnail preview of the video is generated and displayed. The thumbnail preview is generated for a selected view of multiple available views of the video. A correction may also be applied to account for image distortion that results from switching between multiple views in the viewport.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment in accordance with one or more implementations.

FIG. 2 is a diagram depicting example details of a computing device having a video playback module in accordance with one or more implementations.

FIG. 3 is a diagram depicting simultaneously capturing multiple camera angles in a video in accordance with one or more implementations.

FIG. 4 is a flow diagram that describes details of an example procedure for selecting a view of a video in accordance with one or more implementations.

FIG. 5 is a diagram depicting adjusting a viewport of a video to automatically follow an object of interest in accordance with one or more implementations.

FIG. 6 illustrates an example user interface for selecting a view of a video in accordance with one or more implementations.

FIG. 7 illustrates an example scrub bar displaying a thumbnail image of a 360° video that has not selected a particular view according to one or more implementations.

FIG. 8 illustrates an example scrub bar displaying a thumbnail image a 360° video that has selected a particular view according to one or more implementations.

FIG. 9 illustrates an example user interface for generating multiple previews for a thumbnail in accordance with one or more implementations.

FIG. 10 is a flow diagram that describes details of an example procedure for displaying a thumbnail image of a 360° video that has selected a particular view according to one or more implementations.

FIG. 11 is a block diagram of a system that can include or make use of a video playback module and an object identifier module in accordance with one or more implementations.

### DETAILED DESCRIPTION

### Overview

Techniques described herein provide solutions to problems faced by viewers of videos having multiple views that were captured simultaneously in current video viewing applications. In one implementation, the described techniques identify an object in a video having multiple views that were captured simultaneously. An object in a video may be a person, animal, plant, inanimate object, or any entity that is identifiable in a video. The object in the video can be identified either automatically or as a result of an indication from a user. Again returning to the above example, a viewer may identify the person throwing the ball as the object they are interested in viewing. Alternatively or additionally, the video viewing application may select the dog as the object of interest based on detected movement of the dog in the video.

When the object is identified, a viewport in the video viewing application may automatically switch between the multiple views of the video to maintain the object in view within the viewport as the object moves between the multiple views of the video. In the above example in which the viewer selects the person as the identified object, this could entail following the person in the viewport if the person chases the dog after throwing the ball. In the above example in which the video viewing application selects the dog as the object of interest, this could entail following the dog in the viewport when the dog runs to fetch the ball.

Additionally, a viewer of the video may wish to navigate to a different point in time of the video they are viewing. Navigation may include, but is in no way limited to, rewinding the video, fast-forwarding the video, or selection of a particular point in time to jump to in the video. Continuing with the above example, the viewer may wish to jump to the next instance in the video in which the person throws the ball for the dog. The video viewing application may allow a user to hover an input over the scrub bar in the video viewing application, which may result in the display of a thumbnail preview of the video at other points in time than what is currently displayed in the viewport. For example, while the viewport displays the dog running to retrieve the ball, the user may hover over the scrub bar to search for the next instance when the person throws the ball.

Rather than displaying a fisheye configuration in the thumbnail preview when the user hovers over the scrub bar as in current video viewing applications, techniques described herein provide a corrected preview based on the view in the current viewport. A corrected view may relate to an object, a viewing angle, or any other appropriate correction based on the context of the video viewing circumstances. For instance, in the example where the video viewing application has selected the dog as the object of interest, a thumbnail preview may be provided which is corrected to display the dog wherever the dog may be within the multiple views of the video at the point in time in which the viewer hovers over the scrub bar. Alternatively or additionally, the thumbnail preview may be provided which is corrected to display the same viewing angle that is displayed in the viewport, regardless of whether the object has moved. In the same example where the video viewing application has selected the dog as the object of interest, this would entail the thumbnail preview to display the camera viewing angle towards the original location of the person with the ball and the dog. This would allow the viewer to search for a time when the person may throw the ball again from that same location.

In the discussion that follows, a section titled “Operating Environment” is provided that describes one example environment in which one or more implementations can be employed. Next, a section titled “Selecting a View for a Multi-View Video” describes example details and procedures in accordance with one or more implementations. Last, a section titled “Example System” describes example computing systems, components, and devices that can be utilized for one or more implementations of selecting a view of a video.

Operating Environment

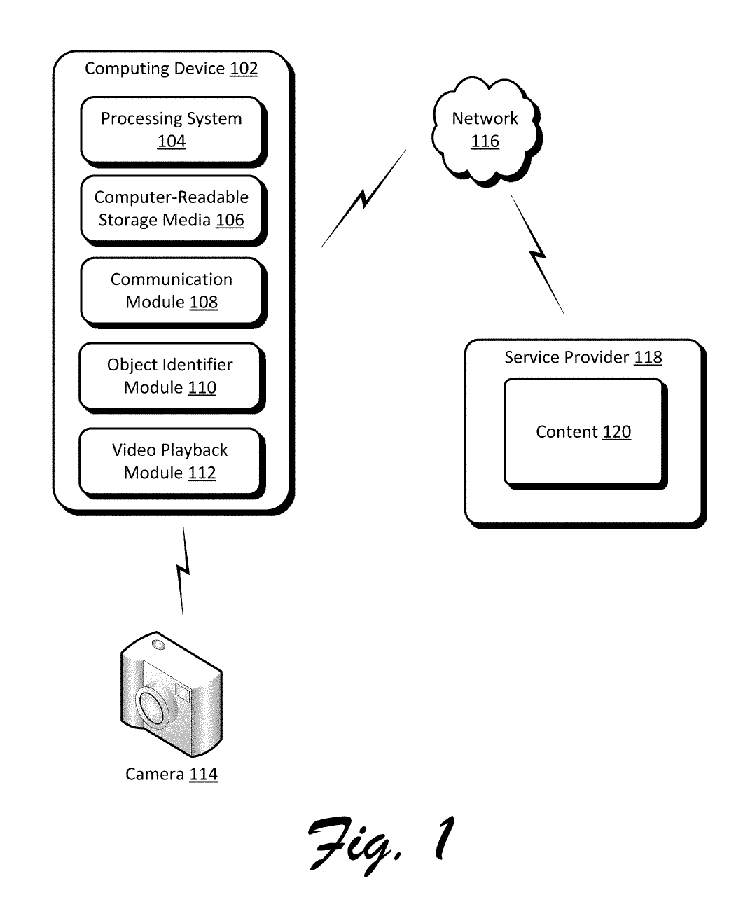

FIG. 1 illustrates an operating environment in accordance with one or more implementations for selecting a view of a multi-view video. The environment includes a computing device 102 having a processing system 104 with one or more processors and devices (e.g., CPUs, GPUs, microcontrollers, hardware elements, fixed logic devices, etc.), and one or more computer-readable media 106. The environment also includes a communication module 108, an object identifier module 110, and a video playback module 112 that reside on the computer-readable media and that are executable by the processing system. The processing system 104 may be configured to include multiple independent processors configured in parallel or in series and one or more multi-core processing units. A multi-core processing unit may have two or more processors (“cores”) included on the same chip or integrated circuit. In one or more implementations, the processing system 104 may include multiple processing cores that provide a range of performance capabilities, processing efficiencies, and power usage characteristics.

The processing system 104 may retrieve and execute computer-program instructions from the communication module 108, object identifier module 110, the video playback module 112, and other applications of the computing device (not pictured) to provide a wide range of functionality to the computing device 102, including but not limited to gaming, office productivity, email, media management, printing, networking, web-browsing, and so forth. A variety of data and program files related to the applications can also be included, examples of which include games files, office documents, multimedia files, emails, data files, web pages, user profile and/or preference data, and so forth.

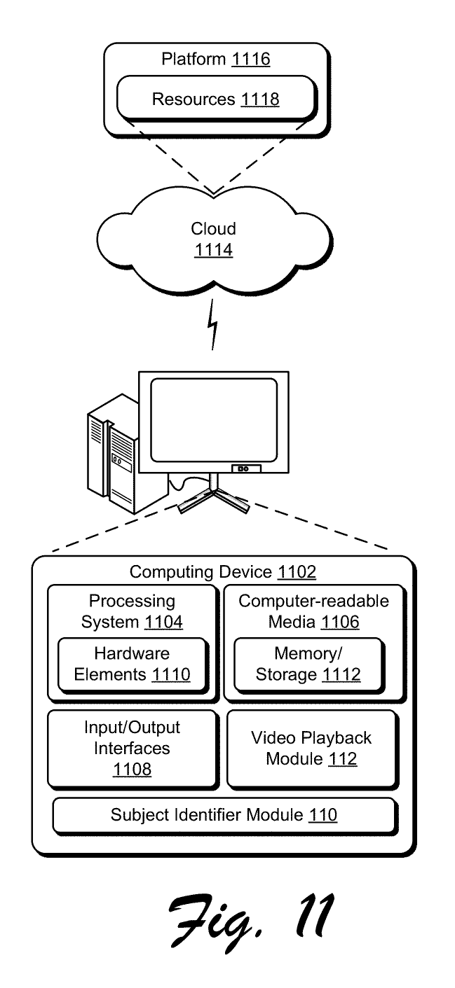

The computer-readable media 106 can include, by way of example and not limitation, all forms of volatile and non-volatile memory and/or storage media that are typically associated with a computing device. Such media can include ROM, RAM, flash memory, hard disk, removable media, and the like. Computer-readable media can include both “computer-readable storage media” and “communication media,” examples of which can be found in the discussion of the example computing system of FIG. 11.

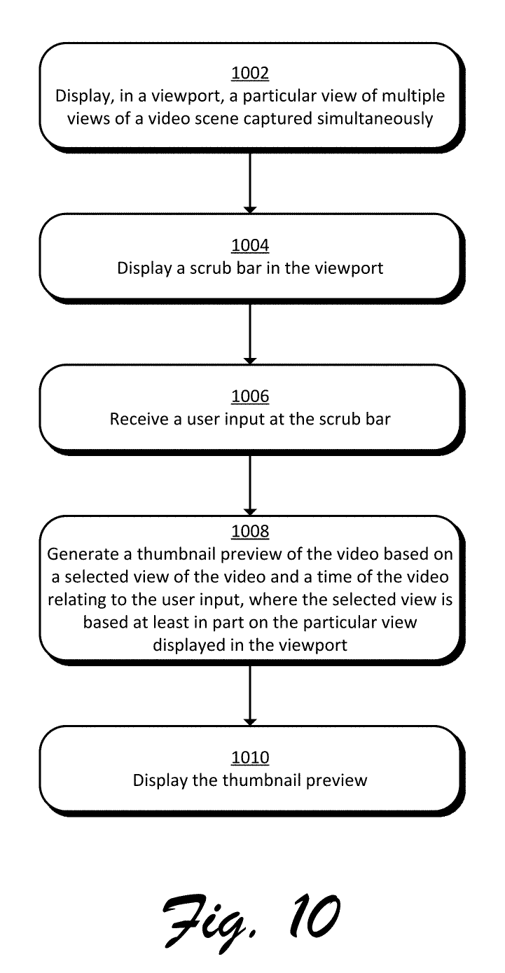

The computing device 102 can be embodied as any suitable computing system and/or device such as, by way of example and not limitation, a desktop computer, a portable computer, a tablet or slate computer, a handheld computer such as a personal digital assistant (PDA), a cell phone, a gaming system, a set-top box, a wearable device (e.g., watch, band glasses, etc.), and the like. For example, the computing device 102 can be implemented as a computer that is connected to a display device to display media content. Alternatively, the computing device 102 may be any type of portable computer, mobile phone, or portable device that includes an integrated display. The computing device 102 may also be configured as a wearable device that is designed to be worn by, attached to, carried by or otherwise transported by a user. Any of the computing devices can be implemented with various components, such as one or more processors and memory devices, as well as with any combination of differing components. One example of the computing device 102 is show and described below in relation to FIG. 10.

A camera 114 is shown as being communicatively coupled to the computing device 102. While one instance of a camera is pictured for clarity, one skilled in the art will contemplate that any suitable number of cameras may be communicatively coupled to computing device 102. The camera 114 may be configured as a photographic camera, a video camera, or both. The camera 114 may be configured as a standalone camera, such as a compact camera, action camera, bridge camera, mirrorless interchangeable-lens camera, modular camera, digital single-lens reflex (DSLR) camera, digital single-lens translucent (DSLT) camera, camcorder, professional video camera, panoramic video accessory, or webcam, to name a few. Additionally or alternatively, the camera 114 may be integrated into the computing device 102, such as in the case of built-in cameras in mobile phones, tablets, PDAs, laptop computers, and desktop computer monitors, for example. Additionally or alternatively, the computing device 102 may itself be a camera, for example a “smart” digital camera, and may comprise one or more of the processing system 104, computer-readable storage media 106, communication module 108, object identifier module 110, and video playback module 112. Other embodiments of the structures of the computing device 102 and the camera 114 are also contemplated.

The camera (or cameras) 114 that is communicatively coupled to computing device 102 may be configured to capture multiple camera views of a real-world scene simultaneously. When multiple camera lenses are used to capture the multiple views, the multiple views may be overlapped and stitched together to provide a contiguous display of the video scene at any point in time. In the case of a video having multiple views, images that have been stitched together can form multi-view frames of the video, such as in the case of 360° videos described above and below. Stitching may be performed by the computing device 102, by the camera 114, or by some other remote device or service, such as service provider 118. In one or more implementations, video captured by the camera 114 may not be able to be displayed in a traditional video viewing application without modifications. For example, the video viewing application may modify the video by cropping portions of the video that extend beyond the confines of the viewport, or distorting the video image to include all or multiple of the camera views such as in a fisheye configuration. Additionally, modifying the video to be played by the video viewing application may be performed by the computing device 102, the camera 114, or by some other device or service, such as service provider 118.

Communication module 108 may facilitate the communicative coupling of the camera 114 to the computing device 102. Communication module 108 may also facilitate the computing device 102 to obtain content 120 from service provider 118 via network 116. Service provider 118 enables the computing device 102 and the camera 112 to access and interact with various resources made available by the service provider 118. The resources made available by service provider 118 can include any suitable combination of content and/or services typically made available over a network by one or more service providers. Some examples of services include, but are not limited to, an online computing service (e.g., “cloud” computing), an authentication service, web-based applications, a file storage and collaboration service, a search service, messaging services such as email and/or instant messaging, and a social networking service.

The resources made available by service provider 118 can include any suitable combination of content and/or services typically made available over a network by one or more service providers. For instance, content 120 can include various combinations of text, video, ads, audio, multi-media streams, applications, animations, images, webpages, and the like. Content 120 may also comprise videos having multiple views of real-world scenes that are captured simultaneously, examples of which are provided above and below. Communication module 108 may provide communicative coupling to the camera 114 and/or service provider 118 via the network 116 through one or more of a cellular network, a PC serial port, a USB port, and wireless connections such as Bluetooth or Wi-Fi, to name a few.

The computing device 102 may also include an object identifier module 110 and a video playback module 112 that operate as described above and below. The object identifier module 110 and the video playback module 112 may be may be provided using any suitable combination of hardware, software, firmware, and/or logic devices. As illustrated, the object identifier module 110 and the video playback module 112 may be configured as modules or devices separate from the operating system and other components. In addition or alternatively, the object identifier module 110 and the video playback module 112 may also be configured as modules that are combined with the operating system of the computing device 102, or implemented via a controller, logic device or other component of the computing device 102 as illustrated.

The object identifier module 110 represents functionality operable to identify objects which may be of interest to a viewer in a video. As discussed above, objects may be one or more of a person, animal, plant, inanimate object, or any entity that is identifiable in a video. Identifying objects in the video may be performed in any suitable way, for instance automatically by techniques such as video tracking or motion capture, to name a few. The object identifier module 110 may also be configured to receive input from a user indicating an object of interest to the user, even if the object of interest is not currently in motion or automatically detected. Additionally or alternatively, the object identifier module 110 may be configured to identify multiple objects in a video using one or multiple techniques described above, either individually or in combination with one another.

The video playback module 112 represents functionality operable to play traditional videos and/or videos having multiple views that were captured simultaneously in a video viewing application. The video playback module 112 may access a video having multiple views of a scene captured simultaneously in multiple directions corresponding to the multiple views. The video may be accessed from the camera 114 or the service provider 118, for example. When playback of the video is initiated in the video playback module 112, the video playback module 112 may display the video in a viewport which can selectively switch between presentation of multiple views of the video. When an object of interest is identified by the object identifier module 110, the video playback module 112 may track the object of interest by automatically switching between the multiple views in order to maintain the object of interest in view within the viewport.

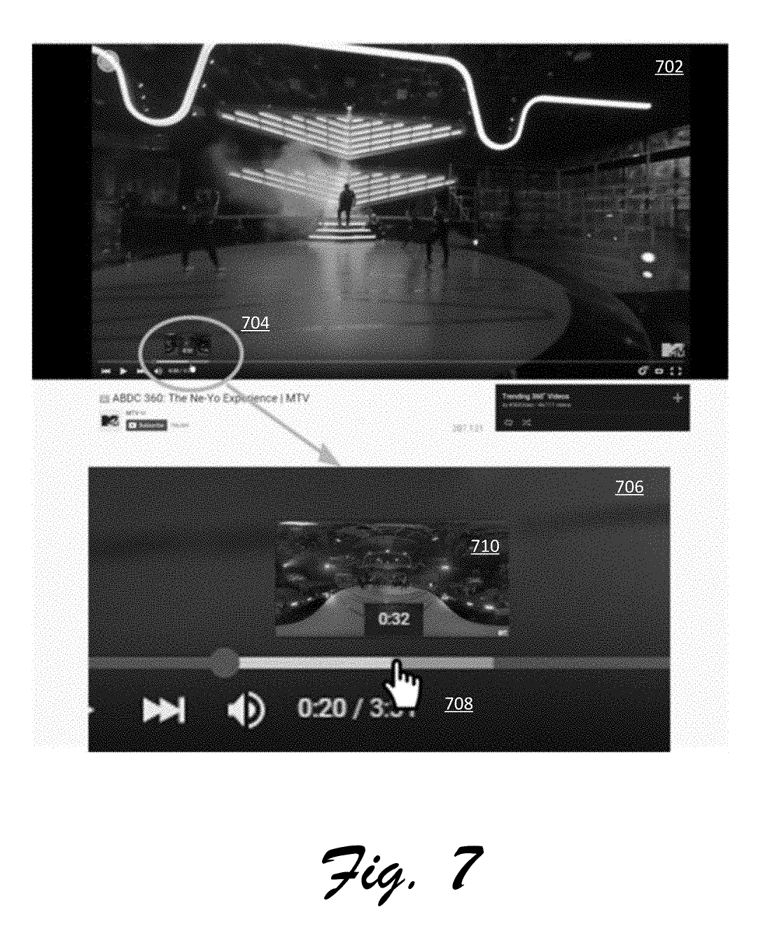

Further, the video playback module 112 may be configured to receive input from a user at a scrub bar of the video viewing application. The scrub bar may be configured to provide a visual representation of a timeline of the video that is updated to show the video's playback progress. Upon receipt of the input, the video playback module may generate a thumbnail preview corresponding to a point in time represented by the input. The view presented in the thumbnail preview can be selected based on a current view of the viewport at the point in time represented by the input. Determining a view to display in the thumbnail preview can be performed in any suitable way, examples of which can be found in relation to FIGS. 7-9. Details regarding these and other aspects of selecting a view for a video are discussed in the following sections.

Having described an example operating environment, consider now example details and techniques associated with one or more implementations of selecting a view for a multi-view video.

Selecting a View for a Video

To further illustrate, consider the discussion in this section of example devices, components, procedures, and implementation details that may be utilized to select a view for a multi-view video as described herein. In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

Example Device

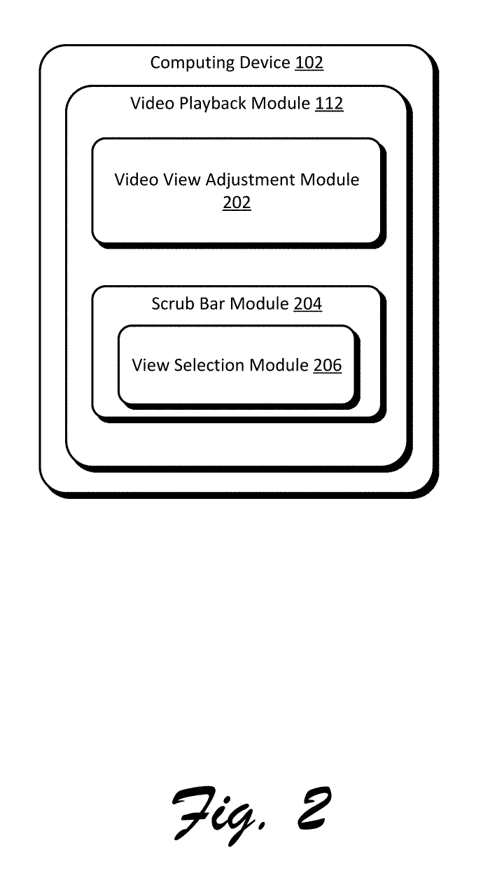

FIG. 2 generally depicts example details of a computing device 102 having a video playback module 112 in accordance with one or more implementations. Computing device 102 also includes processing system 104, computer-readable media 106, communication module 108, and object identifier module 110 as discussed in relation to FIG. 1. Video playback module 112 may be implemented as a separate standalone module, or combined with another application of the computing device 102, or another separate computing device.

By way of example and not limitation, video playback module 112 is depicted as having a video view adjustment module 202, which is representative of functionality to adjust a view in a video viewing application of a video having multiple views that were captured simultaneously. Adjusting a view of a video having multiple views may include manual navigation by a user throughout any of the directions of the multiple views of the video. Additionally or alternatively, adjusting a view of a video having multiple views may include automatic adjustment by the video view adjustment module 202. For example, object identifier module 110 may detect an object of interest that is not visible in the current viewport displaying the video. Upon this detection, the video view adjustment module 202 may automatically adjust the direction of the view of the viewport such that the object of interest is visible in the viewport. In another example, if an object of interest is currently being viewed in the viewport, but is moving throughout multiple views of the video, the video view adjustment module 202 may track the object as it moves throughout the multiple views. These examples of functionality of the video view adjustment module 202 are not intended to be limiting, and any suitable adjustment of the view of a video is contemplated, including combinations of manual and automatic adjustment of the view of the video.

Video playback module 112 is also depicted as having scrub bar module 204, which is representative of functionality to display a visual representation of a timeline of the video that is updated to show the video's playback progress. In one or more implementations, the scrub bar module 204 may allow a user to navigate forward or backward in along a timeline of a video by dragging a handle on the scrub bar, or jump to a specific point in time of a video based on a location of input. The scrub bar module 204 may also be configured to enable other controls to navigate along a timeline of the video, including but not limited to fast-forward and rewind controls. In one or more implementations, the scrub bar module 204 may also be configured to generate a thumbnail preview of the video based on a particular input. For example, one input may be hovering a mouse over a location on the scrub bar, which may result in scrub bar module 204 generating a thumbnail preview of the video at the point in time in the video where the mouse hover occurs. In another example, an input may be received at a rewind button of the scrub bar, and a thumbnail preview may be generated with preview images of the video as the video is rewound. In still another example, an input may be received which drags a handle on the scrub bar to another location in time of the video, and a thumbnail preview may be generated that is representative of the point in time of the video as the handle is dragged. Other ways to manipulate a scrub bar to navigate a video, with associated representative thumbnail previews being generated, are also contemplated.

Scrub bar module 204 is depicted as having view selection module 206, which is representative of functionality to select a view that is generated in a thumbnail preview. As described above and below, when a video having multiple views that were captured simultaneously is displayed in a traditional video viewing application, thumbnail previews that are generated by a scrub bar typically display a fisheye configuration in the thumbnail preview. This can make navigation throughout the timeline of the video difficult for users because of the small size of the thumbnail preview combined with the distortion of the fisheye configuration. The view selection module 206 may be configured to select the view that is displayed in the thumbnail preview according to a context associated with what is displayed in the viewport. In one or more implementations, view selection module 206 may be configured to generate a thumbnail preview based on an object that is being tracked throughout multiple views of the video, such as by video view adjustment module 202. Additionally or alternatively, view selection module 206 may be configured to generate a thumbnail preview based on a current viewing angle of the viewport. Additionally or alternatively, view selection module 206 may be configured to generate a thumbnail preview based on an object of interest identified by object identifier module 110. Other implementations of possible thumbnail previews that can be generated based on a corrected view of a video are also contemplated.

Selecting a View of a Multi-View Video for a Viewport

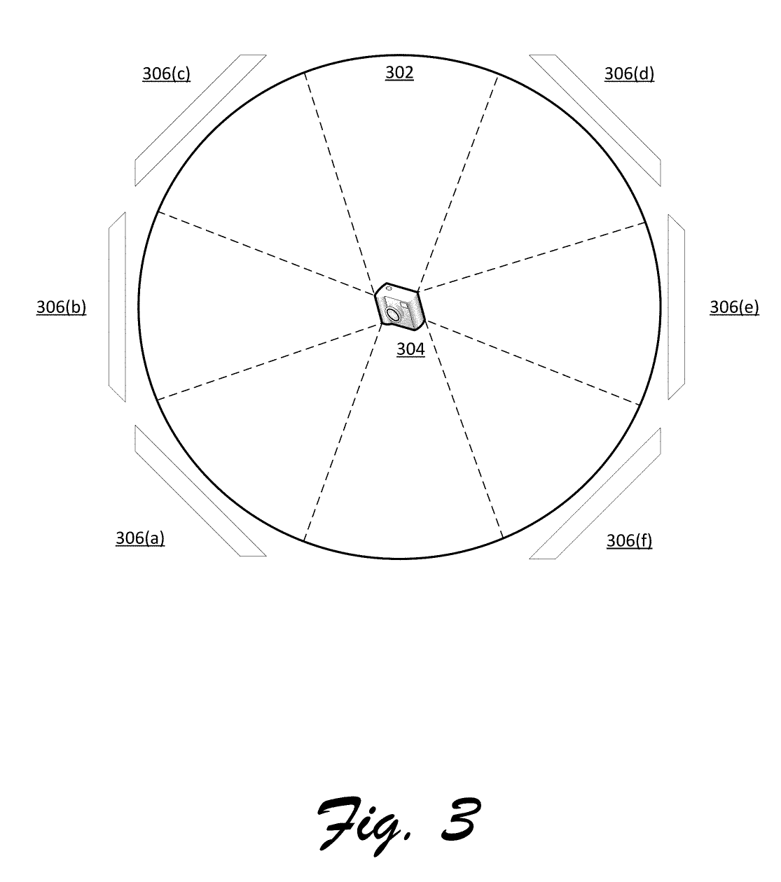

Turning now to FIG. 3, a representation of capturing a video comprising multiple views simultaneously of a real-world scene 302 is depicted. While the real-world scene 302 is depicted as a two-dimensional circle for clarity, one skilled in the art will realize that real-world scene 302 may comprise any configuration of viewing angles in one or more of a horizontal and/or vertical direction. Within the real-world scene 302 is depicted a camera 304 that is configured to capture multiple views simultaneously. Camera 304 may be representative of functionality similar to that described in relation to camera 114 of FIG. 1. Similar to the discussion above with regards to camera 114, the camera 304 may be configured with a single lens or multiple lenses, or alternatively, may be configured as multiple cameras each having a single lens or multiple lenses. Should the camera 304 be implemented as multiple cameras, the multiple cameras may be placed at the same location or at different locations without departing from the scope of the invention described herein.

Also depicted within the real-world scene 302 are views 306(a)-(f), which are representative of camera viewing angles that may be captured by the camera 304. The camera viewing angles represented by views 306(a)-(f) may be configured to capture images or video in multiple different directions simultaneously of the real-world scene 302. In implementations in which camera 304 employs multiple lenses, either configured as one camera or multiple cameras, views 306(a)-(f) may overlap, and/or views 306(a)-(f) may be stitched together to form a contiguous image or video from one view to the next. Alternatively or additionally, gaps may exist between views 306(a)-(f), such that the different directions captured by the camera viewing angles are not contiguous.

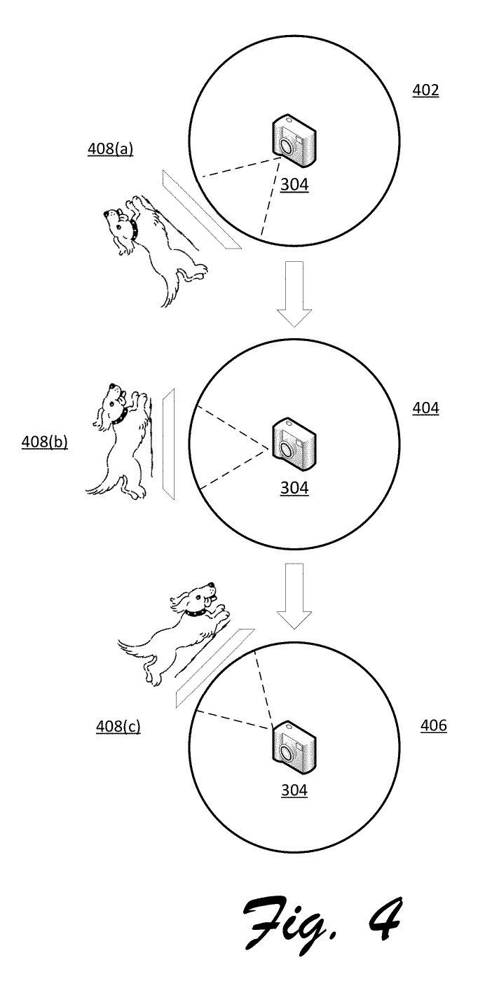

Referring now to FIG. 4, a representation of a sequence of instances of displaying a video is depicted according to techniques described herein. FIG. 4 is representative of instances 402, 404, and 406 of a video captured in accordance with the techniques described in relation to FIG. 3. At instance 402, a real-world scene is depicted which may correspond to real-world scene 302. Within the instance 402 of the real-world scene, camera 304 is shown at a location at which the video was captured. As discussed above, camera 304 is configured to capture multiple views simultaneously. The video captured by camera 304 may comprise these multiple views represented by corresponding camera viewing angles in different directions.

The video captured at instance 402 may comprise a view 408(a), which may be one of the multiple views represented by a corresponding camera viewing angle. View 408(a) depicts a dog running through the real-world scene of instance 402. View 408(a) may be selected to be displayed in a viewport of a video viewing application according to techniques described above and below, such as selection by object identifier module 110. In one or more implementations, view 408(a) may be selected by a viewer. Selection by a viewer may include selecting an object of interest to track as the object of interest moves throughout the multiple views of the video. Alternatively or additionally, selection by a viewer may include selection of a particular one of the multiple views of the video which the viewer wishes to maintain. Further, in one or more implementations, view 408(a) may be automatically selected. For example, when playback of the video is initiated at the beginning of the video, a particular view of the multiple views may be set as a default view by the video viewing application or by a user who uploads the video. Additionally or alternatively, object identifier module 110 may identify an object of interest based on movement of objects throughout the video, the size or color of objects in the video, metadata tags of objects in the video, or similarity of objects in the video to previously indicated objects of interest in other videos by the viewer, to name a few.

If the selected view 408(a) comprises an object of interest, such as the dog depicted in instance 402, video playback module 112 may be configured to track that object of interest as it moves between multiple views of the video. Further, video view adjustment module 202 may be configured to maintain the object of interest in a viewport displaying the video by automatically switching between the multiple views. Instance 404 depicts the dog as the object of interest moving through the real-world scene to a position which is captured by view 408(b) in the video. The video view adjustment module 202 may be configured to maintain the dog in the viewport by automatically switching from view 408(a) to view 408(b). In other words, the video view adjustment module 202 may perform this automatic switch from view 408(a) to view 408(b) without any input from a viewer of the video, maintaining the dog in the viewport as the dog moves through the real-world scene. Additionally, when multiple views of the video are continuous or overlap as described above, the transition between views 408(a) and 408(b) will be continuous and uninterrupted as well, smoothly following the dog throughout the multiple views of the video.

Similarly, instance 406 depicts the dog as the object of interest moving through the real-world scene to a position which is captured by view 408(c) in the video. The video view adjustment module 202 may be configured to continue maintaining the dog in the viewport by automatically switching from view 408(b) to view 408(c). Similar to the discussion above, the video view adjustment module 202 may perform this automatic switch from view 408(b) to view 408(c) without any input from a viewer of the video, maintaining the dog in the viewport as the dog moves through the real-world scene.

While not explicitly pictured, it should be noted that the video view adjustment module 202 may also be configured to terminate tracking an object of interest under certain circumstances. For example, suppose that the dog continues moving through the real-world scene beyond view 408(c). In implementations in which the multiple views of the video stop at view 408(c) (for example, at the edge of a 180° video), the video view adjustment module 202 may cease tracking the dog when the dog moves beyond the outer edge of the captured multiple views. Alternatively or additionally, the dog may move behind another object in the video and no longer be visible, and the video view adjustment module 202 may cease tracking the dog after the dog is no longer visible. Determining whether to terminate tracking an object of interest may be done based on an immediate determination that the object of interest is no longer visible, or may utilize a threshold amount of time to allow the object of interest to return to the video, to name a few examples. Termination of the tracking of an object of interest may also be executed upon receipt of a user input to terminate tracking the object of interest.

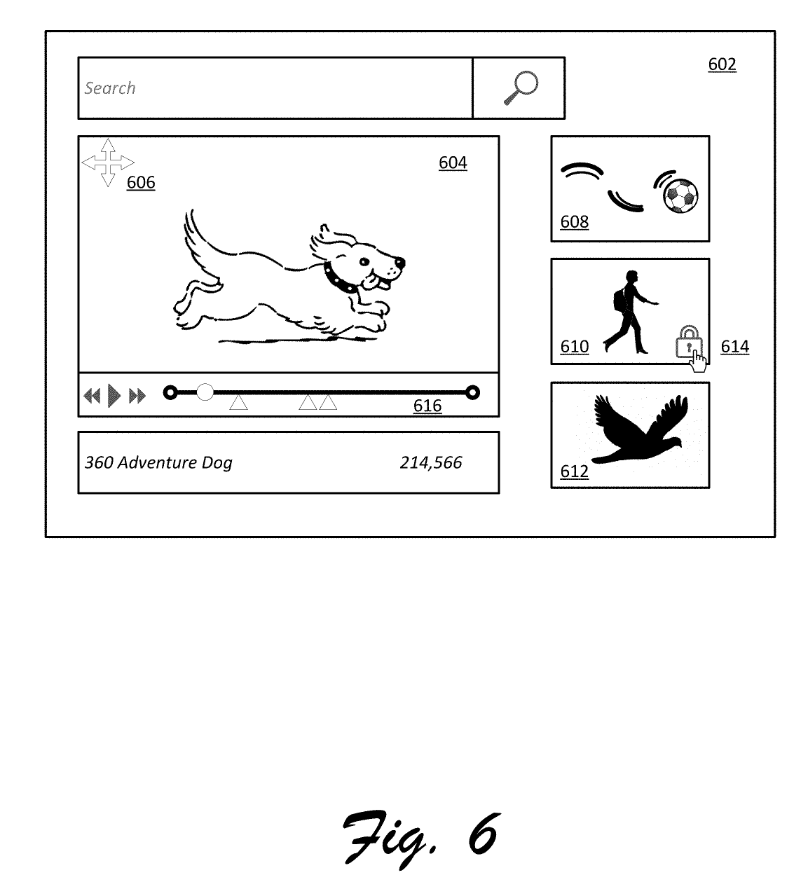

In one or more implementations, video view adjustment module 202 may also be configured to switch between multiple objects of interest in the video. Switching between multiple objects of interest in the video may be based on priorities associated with the multiple objects of interest. Switching between multiple objects of interest in the video may also include terminating tracking of an object of interest, further discussion of which can be found in relation to FIG. 6.

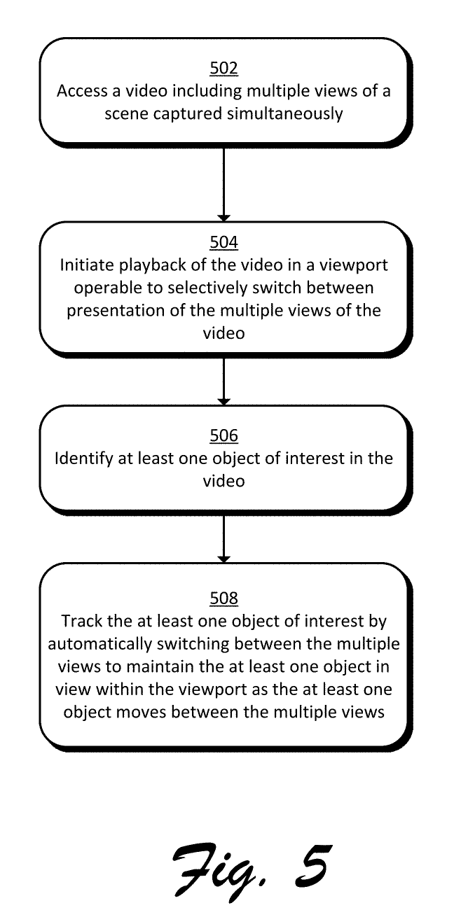

Referring now to FIG. 5, a flow diagram is depicted for an example procedure in which a view of a video for a viewport is selected. The procedure depicted in FIG. 5 can be implemented by way of a suitably configured computing device, such as by way of object identifier module 110, video playback module 112, video view adjustment module 202, and/or other functionality described in relation to the examples of FIGS. 1-4 and/or 6-8. Individual operations and details discussed in relation to FIG. 5 may also be combined in various ways with operations and details discussed herein in relation to the example procedure of FIG. 10.

A video including multiple views of a scene captured simultaneously is accessed (block 502). Videos may be accessed in a number of ways, examples of which are provided above. For instance, a video may be captured by one or more cameras and transferred via a communicative coupling to a computing device. Another example involves capturing the video using one or more cameras integrated with the computing device, such as in the case of a smartphone camera. Yet another example involves obtaining the video from a remote service to display on the computing device, such as from a service provider via a network. Other examples of accessing a video including multiple views of a scene captured simultaneously are also contemplated, such as transferring videos to a device via from a flash drive, hard drive, optical disk, or other media, downloading images from cloud based storage, and so forth. Examples of videos that can be accessed include, but are not limited to, 360° videos on demand (VOD) and live streaming 360° videos, to name a few.

Playback of the video in a viewport is initiated, where the viewport is operable to selectively switch between presentation of the multiple views of the video (block 504). Playback can be initiated by viewer input, such as pressing a “play” button in a user interface containing the viewport. Alternatively or additionally, playback may automatically initiate when the video is accessed. In one or more implementations, playback may be initiated at the beginning of the video, or at a location selected by a user, or at a location selected by a determination made by the video viewing application, to name a few examples.

During playback of the video, at least one object of interest is identified in the video (block 506). Objects of interest may be identified in a number of ways, examples of which are provided above. For example, objects of interest may be identified automatically by a motion detection algorithm configured to perform video tracking or motion capture, for example. Additionally or alternatively, objects of interest may be determined based on movement of objects throughout the video, the size or color of objects in the video, metadata tags of objects in the video, or similarity of objects in the video to previously indicated objects of interest in other videos by the viewer, to name a few. In some implementations, objects of interest may be manually selected by a viewer. Manual selection of an object of interest by a viewer may include selecting an object of interest from the viewport, or selecting one of several objects of interest that the video viewing application automatically detected and enabled for selection by a viewer.

Again during playback of the video, the at least one object of interest is tracked by automatically switching between the multiple views to maintain the at least one object of interest in view within the viewport as the at least one object moves between the multiple views (block 508). Any contemplated techniques for maintaining an object of interest in view within the viewport may be used, such as keeping an object of interest in the center of the viewport as the object moves throughout the multiple views. Objects of interest may be tracked in numerous ways, such as by target representation and localization, filtering and data association, use of a real-time object tracker, or feature tracking, to name a few. In cases where the video is pre-recorded, the video may include predetermined information, such as metadata, regarding how objects of interest may be tracked when the video is accessed. In cases where the video is a live-streaming video, a motion tracking algorithm may be applied at runtime in order to track objects of interest. Conversely, pre-recorded videos may apply a motion tracking algorithm at runtime, while live-streaming videos may include predetermined information regarding how objects of interest may be tracked when the video is accessed. These are intended only as examples, and are not intended to be limiting. As described above, an object of interest can continue to be tracked until the object of interest is no longer present in the video, until an input is received from a user to discontinue tracking the object of interest, or until the video ends.

Turning now to FIG. 6, an example user interface 602 is depicted in accordance with one or more implementations for selecting a view of a multi-view video for a viewport. The user interface 602 includes a viewport 604, which is configured to display videos having multiple views of a real-world scene that were captured simultaneously. The viewport 604 may be configured to track an object of interest according to techniques described above. The viewport 604 may include a navigation control 606, which may be configured to allow manual navigation by a user to move amongst the multiple views of the video. Additionally, the user interface 602 is depicted as having additional viewports 608, 610, and 612. These additional viewports may be added or populated if and when additional objects of interest are identified, such as by the object identifier module 110.

In one or more implementations, the additional viewports may be added or populated based on a list according to a priority of the multiple objects of interest in the video. As discussed above, objects of interest may be determined in numerous ways, such as by movement of the objects within the video or by user selection of objects of interest. In order to assign a priority to multiple objects of interest, numerous factors may be considered, such as an amount of movement of each object, a size of each object, proximity of the objects to each other or the object of interest in the viewport 604, an amount of total time each object has been in the video, or the time at which each object was identified in the video, to name a few. While three additional viewports are depicted in the user interface 602, any suitable number of additional viewports may be provided or added to accommodate an appropriate number of objects to be displayed in the user interface 602.

In the example provided in FIG. 6, the viewports 608, 610, and 612 are depicted as displaying additional objects of interest that have been identified. Similar to the viewport 604, the viewports 608, 610, and 612 may be configured to track these additional objects of interest as they move through multiple views of the video. As discussed above, tracking an object of interest being displayed in a viewport may be terminated for various reasons, including but not limited to the object of interest becoming no longer visible in the video. For example, if the dog pictured in the viewport 604 becomes no longer visible in the video, the viewport 604 may switch to another view containing another object of interest. This may include switching to any one of the views of the viewports 608, 610, 612, or another view of an object of interest that is not displayed in a viewport in the user interface 602. Determining an object of interest to switch to in the viewport 604 may be dependent on the priority of the objects of interest as described above. In one or more implementations, when objects of interest in the viewports 608, 610, and 612 are no longer visible in the video, these viewports may be repopulated with other objects of interest, such as based on the priority of the objects of interest as described above. Alternatively or additionally, additional viewports may be removed to accommodate an appropriate number of objects of interest in the user interface 602.

The user interface 602 may also provide functionality to allow a viewer to “lock on” to an object of interest in the video. Locking on to an object of interest keeps the viewport from switching to another object of interest that may otherwise take the place of the object of interest in the particular viewport. The viewport 610 depicts a user-selectable instrumentality 614 that is selectable by a user to lock on to the particular object of interest in the viewport 610. In this implementation, selecting the lock-on instrumentality 614 causes the viewport 610 to maintain the current object of interest in the viewport 610. While the instrumentality 614 is only depicted in the viewport 610, it is understood that the instrumentality 614 may be implemented in any viewport of the user interface 602 in order to lock on to an object of interest in the respective viewport. Additionally in one or more implementations, two potential objects of interest may come into view in a single viewport, such as the viewport 604. In this scenario, a user-selectable instrumentality may appear to allow a user to lock on to an alternate object of interest in the viewport in order to switch to the alternate object of interest to track in the viewport. While the user-selectable instrumentality 614 is depicted, any suitable means for allowing a user to lock on to an object of interest is contemplated, such as an input on the object in the viewport itself, for instance.

In one or more implementations, objects of interest that are currently being tracked as described above may be switched between viewports or removed from a viewport in the user interface 602. This may be performed in any suitable way. For example, a viewer may be more interested in the bouncing ball being tracked in viewport 608 than the dog being tracked in viewport 604. In order to switch which viewport the objects of interest appear within, the user may drag and drop one object of interest into the other viewport; double-click a desired object of interest in viewports 608, 610, or 612 to move it to the main viewport 604; or utilize a priority list (not shown) to move objects of interest between viewports, to name a few examples. To remove an object of interest from a viewport, a viewer may drag the object of interest to another location such as another viewport, or to a “trash” icon in the user interface (not shown), for example. Additionally or alternatively, the “lock on” functionality described above may be a default setting when an object of interest is detected. In order to remove the object of interest from a viewport, the lock-on instrumentality may be deselected, allowing the object of interest to move out of the viewport without tracking the object.

The user interface 602 further depicts a scrub bar 616 in the viewport 604. As described above, a scrub bar may enable functionality to visually update playback progress along a timeline of a video. A scrub bar may also provide a control to allow a viewer to move forward or backward in the video, such as by dragging a handle or jumping to a specific point in time based on an input. While additional functions associated with a scrub bar are provided below with respect to FIGS. 7-9, the scrub bar 616 depicts indications along a timeline of the video in which objects of interest are detected as either appearing or disappearing from the video. Alternatively or additionally, the indications may specify locations on the timeline in which objects of interest are detected as either appearing or disappearing from a viewport. The locations on scrub bar 616 where objects of interest appear or disappear are indicated by triangles in this example, but any suitable indication is contemplated, such as a preview of the view that the object of interest appears or disappears. These indications provide a viewer with locations which potentially may be of interest to the viewer, and give the viewer a suggestion of where they may wish to jump to along the timeline, for example. In one or more implementations, the indications may be selectable by a viewer to jump to the point in time in the video and display a view in the viewport corresponding to where the object of interest appears or disappears from the video.

Having discussed details regarding selecting a view of a multi-view video for a viewport, consider now details of techniques in which a view for a multi-view video preview is described in relation to the examples of FIGS. 7-9.

Selecting a View for a Multi-View Video Preview

Turning now to FIG. 7, a viewport 702 of a video viewing application is depicted, displaying a video having multiple camera angles of a real-world scene that were captured simultaneously. The view in the viewport 702 is one of the multiple camera angles that were captured simultaneously. The viewport 702 contains a scrub bar, which may be selectable by a user to display a thumbnail preview of the video at a point in time that corresponds to the particular input, examples of which are provided above. As depicted in FIG. 7 at 704, a user has hovered over the scrub bar at a point in time that is 32 seconds from the beginning of the video. An expanded view 706 displays what a thumbnail preview looks like to a viewer in current video viewing applications. The expanded view 706 represents an expanded view of the portion of the viewport indicated by 704.

A user input indicator 708 also shows the user input hovering over the scrub bar at the 32 second position of the video. The thumbnail preview 710 displayed at the 32 second position of the video displays a fisheye configuration of the video, which includes all of the available camera angles that were captured simultaneously at the 32 second position. As noted above, this is the current technique for displaying thumbnail previews for videos having multiple views that were captured simultaneously. Because the thumbnail preview 710 is not selected based on a particular view of the multiple views, the thumbnail preview 710 appears distorted to a viewer. Additionally, since all of the views of the multiple views are fitted into the small thumbnail, the thumbnail preview 710 is not comprehensible for a viewer. Furthermore, because the current view in the viewport 702 is not taken into consideration when generating the thumbnail preview 710, the actual video frame that the viewer will see if the viewer navigates to that location is not the frame being shown in the thumbnail preview 710. This can lead to viewer frustration when trying to navigate the video.

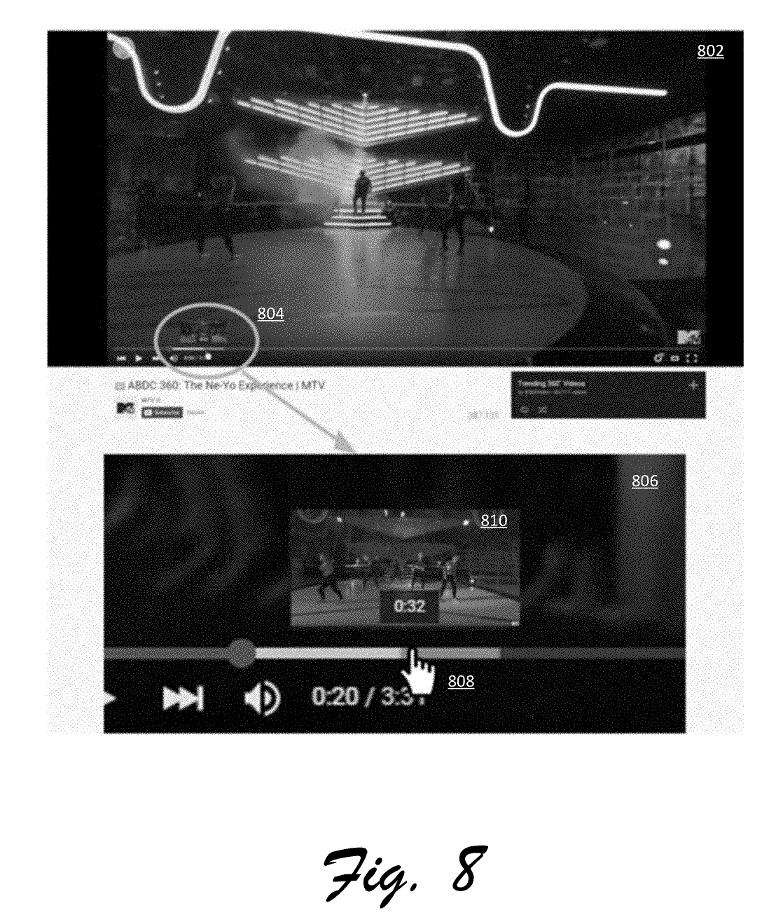

Turning now to FIG. 8, a viewport 802 of a video viewing application is depicted, again displaying a video having multiple camera angles of a real-world scene that were captured simultaneously. In one or more implementations, the view that is currently displayed in viewport 802 is saved and used to generate a thumbnail preview, such as the thumbnail preview shown at 804. Saving the view that is currently in the viewport can be implemented in numerous ways. For example, a video viewing application may save frames which correspond to a particular view that is currently displayed in the viewport and generate thumbnail previews based on the saved frames corresponding to the particular view. Alternatively or additionally, a video viewing application may save frames which correspond to an object of interest as the object of interest moves through the multiple views and generate thumbnail previews based on the saved frames corresponding to the object of interest. Techniques regarding identification and tracking an object of interest as the object of interest moves throughout multiple views of a video are described above in relation to FIGS. 1-6.

In one or more implementations, the video viewing application may switch between views and/or objects of interest when saving frames and generating a thumbnail preview depending on the context of the video. For instance, frames may be saved and thumbnail previews generated for a particular view until an object of interest enters the video and/or the particular view. When the object of interest enters the video and/or the particular view, the video viewing application may begin saving frames for generating thumbnail previews for the object of interest rather than the particular view. Additionally or alternatively, a video viewing application may save frames and generate thumbnail previews for an object of interest as the object of interest moves throughout the multiple views of the video. If the object of interest leaves the view of the video, or another object of interest appears, the video viewing application may save frames for generating thumbnail previews for a different object of interest, such as based on the priority techniques described above. Other techniques for switching between views and/or objects of interest when saving frames and generating thumbnail previews are also contemplated. Additionally, while the above implementations describe a video viewing application saving frames for generating thumbnail previews, saving and generating may be performed by a browser, application, device, remote service, or any combination of these implementations, to name a few.

Returning to FIG. 8, expanded view 806 depicts a user input indicator 808 hovering over the scrub bar of the viewport 802 at the 32 second position. According to techniques described herein, the video viewing application has generated a thumbnail preview 810. Rather than the fisheye configuration depicted in the thumbnail preview 710, the thumbnail preview 810 displays a selected view of the multiple views, in this instance based on the current view displayed in the viewport 802. In this example, the thumbnail preview 810 is selected to display the same view corresponding to the camera direction of the viewport 802, but at a point in time that is different than what is displayed in the viewport 802. While a selected view for a thumbnail preview based on a current view of a viewport is depicted, this is not intended to be limiting, and any particular view for a thumbnail preview is contemplated.

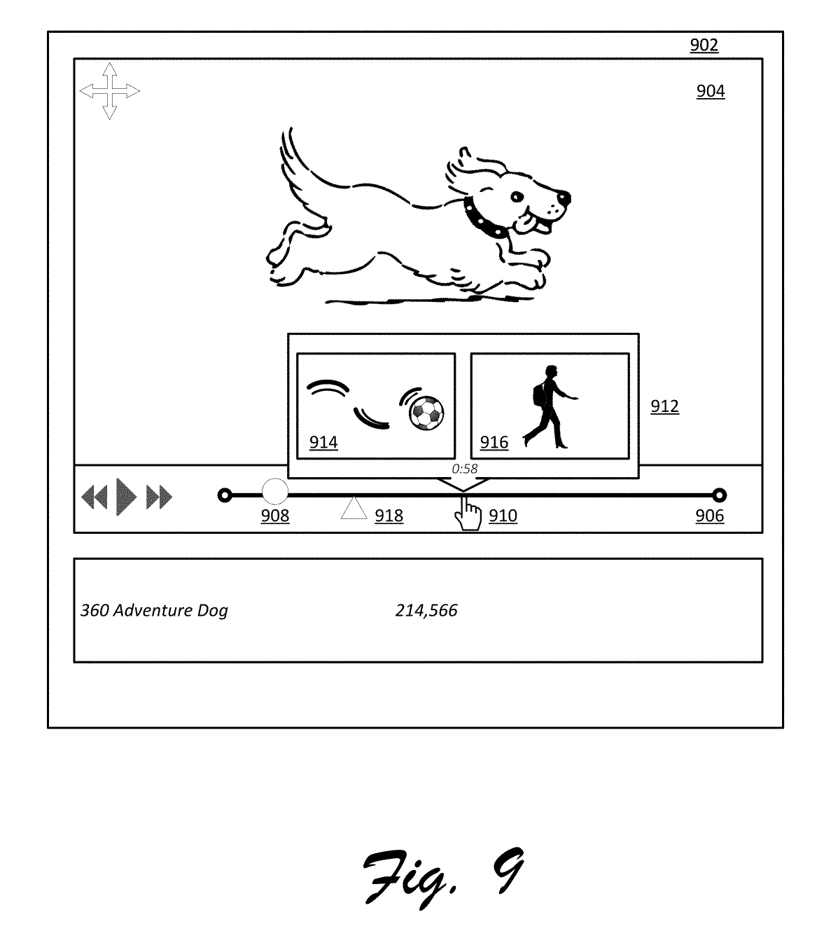

Turning now to FIG. 9, an example user interface 902 is depicted in accordance with one or more implementations for selecting a view for a video preview. The user interface 902 may be configured to have similar capabilities as the user interface 602 described in relation to FIG. 6. For example, the user interface 902 includes a viewport 904, which is configured to display videos having multiple views of a real-world scene that were captured simultaneously. The viewport 904 may be configured to track an object of interest according to techniques described above. While not depicted in FIG. 9, the user interface 902 may be configured to have additional viewports that may be added or populated if and when additional objects of interest are identified, such as by the object identifier module 110.

The user interface 902 is also depicted as having a scrub bar 906, which provides a visual indication of playback of the video in the viewport 904 along a timeline of the video. For example, an indicator 908 visually represents the location along the timeline of the video that is currently displayed in the viewport 904. Also depicted on the scrub bar 906 is an input indicator 910. The input indicator 910 may have similar functionality to the input indicators 708 and 808 described in relation to FIGS. 7 and 8, respectively. In this example, the input indicator 910 is shown hovering over the scrub bar 906 at the 58 second position on the timeline of the video. As a result of this input from the input indicator 910, a thumbnail preview 912 has been generated and is displayed on the scrub bar 906.

Similar to the discussion of FIG. 8, the thumbnail preview 912 may be configured to display selected views of multiple views of the video, but at a point in time that is different than what is displayed in the viewport 904. In one or more implementations, however, thumbnail preview 912 may be configured to display multiple selected views of the multi-view video, such as previews 914 and 916. In this example, previews 914 and 916 display additional objects of interest that are present in the multi-view video at the 58 second position. The previews 914 and 916 may be generated by first detecting additional objects of interest using techniques described above, such as by a motion detection algorithm. Once the additional objects of interest are detected, the frames of the video may be saved that track the additional objects of interest as they move throughout the multi-view video. The saved frames tracking the additional objects of interest as they move throughout the multi-view video can then be used to generate the thumbnail previews 914 and 916 at any point in time along the timeline of the video.

Additionally depicted in FIG. 9 is an indicator 918 on the scrub bar 906. The indicator 918 is representative of functionality to provide an indication of when an object of interest may enter or leave the view of the multi-view video. In this example, the indicator 918 provides an indication of when the object of interest in the main viewport 902, the dog, leaves the view of the multi-view video. The previews 914 and 916 may be generated based on this circumstance. For instance, because the object of interest in the main viewport is no longer visible in the video, thumbnail previews may be generated to give a viewer previews of other objects of interest that the viewer may be interested in viewing. These previews, such as previews 914 and 916, may be selectable by the viewer to not only jump to the particular point in time of the video, but also select an object of interest to track and view in the main viewport 902 beginning at the selected point in time of the video.

A countless number of possibilities exist for generating multiple thumbnail previews for a multi-view video. In one or more implementations, one of the multiple previews may be the preview based on an object of interest in the current view displayed in the viewport, alongside previews of other objects of interest. In this case, the preview based on the current view displayed in the viewport may be more prominently displayed (e.g., larger, highlighted, etc.) than the previews of the other objects of interest. Alternatively or additionally, one or more of the previews displayed in the thumbnail may be based on a particular view in a direction of interest, rather than tracking an object of interest as the object of interest moves throughout the real-world scene of the video. In fact, any of the techniques described in relation to FIGS. 1-8 may be employed, either individually or in combination, to generate an appropriate and dynamic thumbnail preview by way of selecting one or more views of a multi-view video.

Details regarding these and other aspects of selecting a view for a video preview are described in relation to the following example procedures.

Example Procedure

This section discusses additional aspects of selecting a view of a multi-view video preview in relation to the example procedure of FIG. 10. The procedures described in this document may be implemented utilizing the environment, system, devices, and components described herein and in connection with any suitable hardware, software, firmware, or combination thereof. The procedures are represented as a set of blocks that specify operations performed by one or more entities and are not necessarily limited to the orders shown for performing the operations by the respective blocks.

FIG. 10 is a flow diagram which describes details of an example procedure for selecting one or more views for a multi-view video preview. The procedure of FIG. 10 can be implemented by way of a suitably configured computing device, such as by way of video playback module 112, scrub bar module 204, and/or other functionality described in relation to the examples of FIGS. 1-9. Individual operations and details discussed in relation to FIG. 10 may also be combined in various ways with operations and details discussed herein in relation to the example procedure of FIG. 5.

A particular view of multiple views of a video scene that were captured simultaneously is displayed in a viewport (block 1002). The particular view may be selected for display in a number of ways, examples of which are provided above. One example includes a default view that has been selected by the creator of the video or by a video viewing application. Another example includes a user selection of the particular view, which could be based on an object of interest to the viewer or a view of interest to the viewer. Other examples of displaying a particular view of multiple views in a viewport are also contemplated.

A scrub bar is displayed in the viewport (block 1004). The scrub bar may be a visual representation of an amount of playback of the video, and may also be configured to receive various user inputs to navigate a timeline associated with the video. Some examples of possible inputs associated with navigation of the timeline may include a rewind input, a fast-forward input, a hover input, a drag input, a selection input, and other navigation inputs. Other functionalities of the scrub bar are also contemplated, including functionalities that are not associated with navigation of the timeline associated with the video.

A user input is received at the scrub bar (block 1006). The user input may correspond to navigation of a timeline associated with the video, such as by the examples provided above. For instance, a viewer may hover over a point in time of the video that they are considering jumping to. The viewer may then choose to jump to the point in time of the video by a selection input at the chosen point in time, or may continue to look for another point in time using the hover input. In another example, the viewer may use a rewind input provided by the scrub bar to navigate to a previously viewed portion of the video. Numerous additional examples of receiving a user input at a scrub bar are also contemplated.

A thumbnail preview of the video is generated based on one or more selected views of the video and a time of the video relating to the user input, where a selection is based at least in part on the particular view displayed in the viewport (block 1008). In one or more implementations, the thumbnail preview may be generated based only on the particular view that is currently displayed in the viewport, and may continue to show a preview of the particular view for an input received at the scrub bar corresponding to the time of the user input on the timeline of the video. Alternatively or additionally, the thumbnail preview may be based on a correction applied to frames of the video to track an object of interest that is identified in the particular view in the viewport. In this scenario, the thumbnail preview may display a different view of the multiple views that contains the object of interest if the object of interest moves to the different view at the point in time on the timeline of the video selected by the viewer. Displaying a particular view and displaying a view containing an object of interest are not necessarily exclusive, and examples of combining these implementations are described above. In one or more implementations, a video viewing application may save the corrections to the frames for generating thumbnail previews, examples of which are provided above.

Further, while the thumbnail preview in this implementation is described as being generated based on the particular view displayed in the viewport, other embodiments are also contemplated. For example, one or more additional objects of interest may be presented in the thumbnail preview that may be selectable by the user. In this example, the thumbnail preview may be generated by selecting additional objects of interest and tracking the additional objects of interest as they move throughout the multiple views, examples of which are provided above. In fact, any of the techniques described in relation to FIGS. 1-8 may be employed, either individually or in combination, to generate an appropriate and dynamic thumbnail preview by way of selecting one or more views of a multi-view video.

The thumbnail preview comprising the corrected frames is displayed (block 1010). The thumbnail preview may be displayed at the location on the scrub bar representing the point in time of the thumbnail preview. The display of the thumbnail preview may include additional information, such as a timestamp of the location of the thumbnail preview on the video playback timeline. Other configurations of displaying the thumbnail preview are also contemplated.

Having described example details and procedures associated with selecting a view for a video, consider now a discussion of an example system that can include or make use of these details and procedures in accordance with one or more implementations.

Example Device

FIG. 11 illustrates an example system that includes an example computing device 1102 that is representative of one or more computing systems and/or devices that may implement the various techniques described herein. The computing device 1102 may be, for example, a server of a service provider, a device associated with a client (e.g., a client device), an on-chip system, and/or any other suitable computing device or computing system.

The example computing device 1102 as illustrated includes a processing system 1104, one or more computer-readable media 1106, and one or more I/O interfaces 1108 that are communicatively coupled, one to another. Although not shown, the computing device 1102 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including hardware elements 1110 that may be configured as processors, functional blocks, and so forth. This may include implementation in hardware as an application specific integrated circuit or other logic device formed using one or more semiconductors. The hardware elements 1110 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1106 is illustrated as including memory/storage 1112. The memory/storage 1112 represents memory/storage capacity associated with one or more computer-readable media. The memory/storage 1112 may include volatile media (such as random access memory (RAM)) and/or nonvolatile media (such as read only memory (ROM), Flash memory, optical disks, magnetic disks, and so forth). The memory/storage 1112 may include fixed media (e.g., RAM, ROM, a fixed hard drive, and so on) as well as removable media (e.g., Flash memory, a removable hard drive, an optical disc, and so forth). The computer-readable media 1106 may be configured in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone for voice operations, a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 1102 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1102. By way of example, and not limitation, computer-readable media may include “computer-readable storage media” and “communication media.”

“Computer-readable storage media” refers to media and/or devices that enable storage of information in contrast to mere signal transmission, carrier waves, or signals per se. Thus, computer-readable storage media does not include signal bearing media, transitory signals, or signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Communication media” may refer to signal-bearing media that is configured to transmit instructions to the hardware of the computing device 1102, such as via a network. Communication media typically may embody computer readable instructions, data structures, program modules, or other data in a modulated data signal, such as carrier waves, data signals, or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules including the processing system 104, subject identifier module 110, video playback module 112, and other program modules may be implemented as one or more instructions and/or logic embodied on some form of computer-readable storage media and/or by one or more hardware elements 1110. The computing device 1102 may be configured to implement particular instructions and/or functions corresponding to the software and/or hardware modules. Accordingly, implementation of modules as a module that is executable by the computing device 1102 as software may be achieved at least partially in hardware, e.g., through use of computer-readable storage media and/or hardware elements 1110 of the processing system. The instructions and/or functions may be executable/operable by one or more articles of manufacture (for example, one or more computing devices 1102 and/or processing systems 1104) to implement techniques, modules, and examples described herein.

As further illustrated in FIG. 11, the example system enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system of FIG. 11, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1102 may assume a variety of different configurations, such as for computer, mobile, and camera uses. Each of these configurations includes devices that may have generally different constructs and capabilities, and thus the computing device 1102 may be configured according to one or more of the different device classes. For instance, the computing device 1102 may be implemented as the computer class of a device that includes a personal computer, desktop computer, a multi-screen computer, laptop computer, netbook, and so on.

The computing device 1102 may also be implemented as the mobile class of device that includes mobile devices, such as a mobile phone, portable music player, portable gaming device, a tablet computer, a multi-screen computer, and so on. The computing device 1102 may also be implemented as the camera class of device that includes devices having or connected to a sensor and lens for capturing visual images. These devices include compact camera, action camera, bridge camera, mirrorless interchangeable-lens camera, modular camera, digital single-lens reflex (DSLR) camera, digital single-lens translucent (DSLT) camera, camcorder, professional video camera, panoramic video accessory, or webcam, and so on.

The techniques described herein may be supported by these various configurations of the computing device 1102 and are not limited to the specific examples of the techniques described herein. This is illustrated through inclusion of the subject identifier module 110 and the video playback module 112 on the computing device 1102. The functionality represented by the subject identifier module 110 and the video playback module 112 and other modules/applications may also be implemented all or in part through use of a distributed system, such as over a “cloud” 1114 via a platform 1116 as described below.

The cloud 1114 includes and/or is representative of a platform 1116 for resources 1118. The platform 1116 abstracts underlying functionality of hardware (e.g., servers) and software resources of the cloud 1114. The resources 1118 may include applications and/or data that can be utilized while computer processing is executed on servers that are remote from the computing device 1102. Resources 1118 can also include services provided over the Internet and/or through a subscriber network, such as a cellular or Wi-Fi network.

The platform 1116 may abstract resources and functions to connect the computing device 1102 with other computing devices. The platform 1116 may also serve to abstract scaling of resources to provide a corresponding level of scale to encountered demand for the resources 1118 that are implemented via the platform 1116. Accordingly, in an interconnected device embodiment, implementation of functionality described herein may be distributed throughout the system of FIG. 11. For example, the functionality may be implemented in part on the computing device 1102 as well as via the platform 1116 that abstracts the functionality of the cloud 1114.

### CONCLUSION

Although the example implementations have been described in language specific to structural features and/or methodological acts, it is to be understood that the implementations defined in the appended claims are not necessarily limited to the specific features or acts described. Rather, the specific features and acts are disclosed as example forms of implementing the claimed features.

1. In a digital media viewing environment, a method to track objects of interest during playback of a video via a video viewing application, the method comprising:
accessing a video including multiple views of a scene captured simultaneously via a camera system configured to capture images for the scene in multiple directions corresponding to the multiple views;
initiating playback of the video in a viewport of the video viewing application, the viewport operable to selectively switch between presentation of the multiple views of the video; and
during playback of the video:
identifying at least one object of interest in the video; and
tracking the at least one object that is identified by automatically switching between the multiple views to maintain the at least one object in view within the viewport as the at least one object moves between the multiple views.

2. The method of claim 1, wherein the camera system comprises multiple camera lenses arranged in positions to capture the multiple views.

3. The method of claim 1, wherein the images captured in the multiple directions are stitched together to form multi-view frames of the video.

4. The method of claim 1, wherein the identifying the at least one object of interest in the video comprises recognizing a moving object in the video by a motion detection algorithm.

5. The method of claim 4, wherein the motion detection algorithm is applied at runtime.

6. The method of claim 1, wherein the viewport is exposed in a user interface of the video viewing application, the user interface configured to display one or more additional viewports in addition to the viewport.

7. The method of claim 6, wherein the one or more additional viewports are configured to track additional objects of interest, respectively, by automatically switching between the multiple views to maintain the additional objects of interest in view within the respective additional viewports as the additional objects move between the multiple views.

8. The method of claim 6, wherein the one or more additional viewports are selectable to switch a view displayed in a selected additional viewport with a view displayed in the viewport.

8. The method of claim 1, further comprising:
receiving a user input to select a different object of interest to be viewed in the viewport; and
causing the viewport to switch from tracking the object to track the different object.

9. The method of claim 1, further comprising:
identifying a different object of interest in the video; and
responsive to the at least one object of interest becoming no longer visible in the video, causing the viewport to switch from tracking the object to track the different object.

10. The method of claim 1, further comprising:
displaying a scrub bar in the viewport, the scrub bar configured to provide a visual representation that is updated to show the video's playback progress on a timeline of the video; and
indicating, on the scrub bar, a point in time on the timeline of the video in which an object of interest appears or disappears from view of the video.

11. The method of claim 10, wherein the indication of the point in time on the timeline is selectable to jump to the point in time in the video and display a view in the viewport corresponding to where the object of interest appears or disappears from the video.

12. A computing device comprising:
one or more processors; and
one or more computer-readable media having instructions stored thereon that, when executed by the one or more processors, implement a video viewing application configured to perform operations including:
displaying, in a viewport of the video viewing application, a particular view of multiple views of a video scene captured simultaneously via a camera system configured to capture images for the scene in multiple directions corresponding to the multiple views;
displaying a scrub bar of the viewport operable to facilitate a visual representation that is updated to show the video's playback progress;
receiving, at the scrub bar, a user input;
responsive to receiving the user input at the scrub bar, generating a thumbnail preview of the video based on a selected view of the video and a time of the video relating to the user input, the selected view based at least in part on the particular view that is currently displayed in the viewport; and
displaying the thumbnail preview.

13. The computing device of claim 12, wherein the user input comprises a hover input, a drag input, a selection input, a rewind input, or a fast-forward input.

14. The computing device of claim 12, wherein the selected view is further based on a correction applied to frames of the video corresponding to an object of interest that is currently displayed in the particular view.

15. The computing device of claim 14, wherein the correction applied to the frames of the video further comprises tracking the object of interest by automatically switching between the multiple views to maintain the object of interest in view within the thumbnail as the object of interest moves between the multiple views.

16. The computing device of claim 12, further comprising saving the correction applied to the frames to be used in generating the thumbnail preview.

17. A method comprising:
accessing a video in a video viewing application, the video including multiple views of a scene captured simultaneously via a camera system configured to capture images for the scene in multiple directions corresponding to the multiple views;
initiating playback of the video in a viewport of the video viewing application, the viewport operable to selectively switch between presentation of the multiple views of the video; and
during playback of the video:
identifying an object of interest in the video based at least in part on an amount of movement of the object of interest in the video;
tracking the object that is identified by automatically switching between the multiple views to maintain the object in view within the viewport as the object moves between the multiple views;
receiving a user input at a scrub bar of the viewport indicative of a point in time of the video;
generating a thumbnail preview of the video based on a correction applied to frames of the video and a time of the video relating to the user input, the correction based at least in part on the particular view that is currently displayed in the viewport or a location of the object as the object is tracked in the multiple views of the video; and
displaying the thumbnail preview.

18. The method of claim 17, wherein the camera system comprises multiple camera lenses configured to capture the multiple views, and wherein the multiple views correspond to positions of the lenses of the camera system.

19. The method of claim 17, wherein the viewport is exposed in a user interface of the video viewing application, the user interface configured to display one or more additional viewports in addition to the viewport.

20. The method of claim 17, wherein the user input comprises a hover input, a drag input, a selection input, a rewind input, or a fast-forward input.
